(19) United States
(12) Patent Application Publication
(10) Pub. No.: US 2014/0191117 A1
(43) Pub. Date: Jul. 10, 2014

(54) Chromatography System with LED-Based Light Source

(71) Applicant: Bio-Rad Laboratories, Inc., Hercules, CA (US)

(72) Inventors: Wayne Bland, Martinez, CA (US); Glenn Price, Riverside, CA (US); Donald Hutson, Albany, CA (US)

(73) Assignee: Bio-Rad Laboratories, Inc., Hercules, CA (US)

(21) Appl. No.: 14/152,960

(22) Filed: Jan. 10, 2014

Related U.S. Application Data
(60) Provisional application No. 61/751,227, filed on Jan. 10, 2013.

(51) Int. Cl. G01J 1/04

(52) U.S. Cl. CPC G01J 1/0488
USPC 250/226

(57) ABSTRACT

A detector system having a single emitter body. The emitter body has a plurality of light emitting diodes (LEDs) for emitting a plurality of wavelengths. Each LED adapted to emit a different wavelength of light. A broadband filter is adapted to receive the plurality of wavelengths. A detector arrangement adapted to receive the plurality of wavelengths filtered by the broadband filter. A controller adapted to control the plurality of LEDs and detector arrangement.

### CROSS-REFERENCES TO RELATED APPLICATIONS

This application claims the benefit of U.S. Provisional Application No. 61/751,227, filed on Jan. 10, 2013, which is incorporated by reference herein.

### BACKGROUND OF THE INVENTION

Many detection arrangements for chromatography systems operate on the principle of exposing a sample to a particualar wavelength of energy to determine physical properties of the sample. For example, often the refractive index or ultra-violet absorbence of a sample is measured. Energy is often provided in the form of a laser beam, since detection systems are very sensitive to stray energy detection.

Laser based systems, however, are expensive to implement and lack flexibility in changing detection parameters. For example, each particular property to be measured may require a different laser with a corresponding different wavelength output. Thus, changing the detection parameters may be implausible for many chromatography systems and thus limit scientific progress. Accordingly, there is a need for an improved detection system.

### BRIEF SUMMARY OF THE INVENTION

Some embodiments of the invention relate to a use of light emitting diode (LED) light source in a detector for a chromatography system, e.g., for protein purification within 280-320 nm. The light source can be a single, dual, triple or quadruple LED device housed in a single package. The system is capable of using individual sources and multiplexing them to read up to 1, 2, 3, or 4 wavelengths. A broadfilter can be used to remove any unwanted or straylight artifacts from the LED construction.

Some embodiments relate to a detector system having a single emitter body comprising a plurality of LEDs for emitting a plurality of wavelengths, each LED adapted to emit a different wavelength of light. A broadband filter is adapted to receive the plurality of wavelengths. A detector arrangement is adapted to receive the plurality of wavelengths filtered by the broadband filter. A controller adapted to control the plurality of LEDs and detector arrangement.

Some embodiments relate to a method for operating a detector system. In the method, a single emitter body comprising a plurality of LEDs is controlled to emit a plurality of wavelengths to a broadband filter, each LED adapted to emit a different band of light. A detector arrangement is controlled to receive the plurality of wavelengths filtered by the broadband filter. And a reference signal and a sample signal received from the detector arrangement are processed to determine a property of a sample.

In some embodiments, the single emitter body comprises 2-10 LEDs.

In some embodiments, the single emitter body comprises 4 LEDs.

In some embodiments, the single emitter body comprises a 280 nm LED and a 260 nm LED.

In some embodiments, the single emitter body further comprises a 320 nm LED.

In some embodiments, the broadband filter has a bandwidth of 260-320 nm.

In some embodiments, the detector arrangement comprises a sample detector adapted to detect absorbance of a sample and a reference detector.

In some embodiments, a beam splitter is located between the broadband filter and the detector arrangement.

In some embodiments, each LED of the plurality of LEDs is operated individually.

In some embodiments the plurality of LEDs is operated to pulse.

### BRIEF DESCRIPTION OF THE DRAWINGS

FIGS. 1 and 2 are schematic diagrams of respective systems for controlling a LED based light source and an associated detector arrangement, according to many embodiments.

FIGS. 3A and 3B are schematic pin diagrams of respective LED light sources, according to many embodiments.

FIGS. 4A-4C are schematic diagrams of respective LED driver circuits, according to many embodiments.

FIG. 5 is a graph showing a comparative test result of an LED based chromatography system, according to many embodiments.

### DETAILED DESCRIPTION OF THE INVENTION

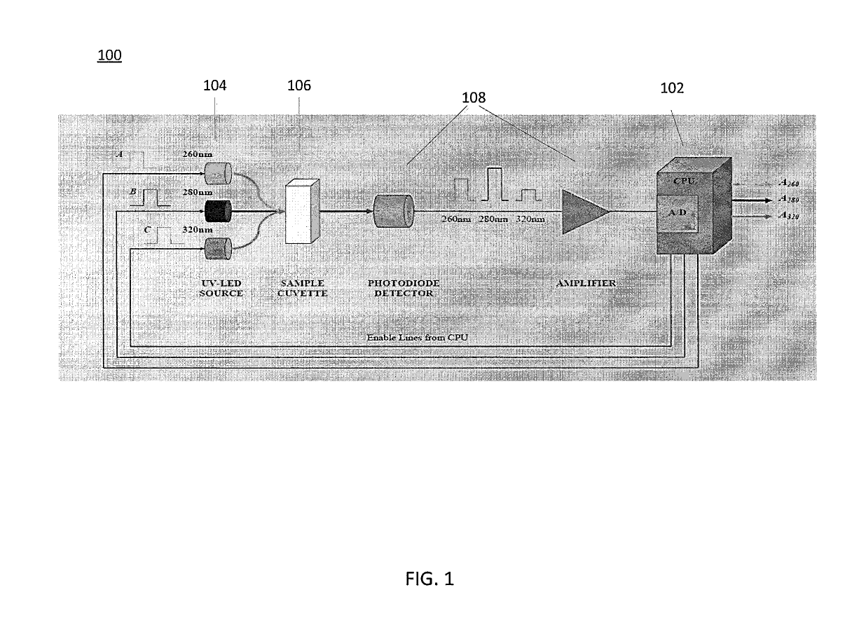

FIG. 1 shows a schematic diagram of a system 100 for controlling a LED based light source and an associated detector arrangement. The system 100 may be a sub-system of a greater system, such a chromatography system.

The system includes a controller 102. The controller can be a special purpose or general purpose computing system. The controller generally includes at least one processor (CPU) and a systems bus for connecting the processor to peripheral devices, inputs, and outputs, such as an analog to digital (A/D) converter. For example, a communications port can be used to connect the controller to a wide area network such as the Internet, a mouse input device, or a scanner. The interconnection via the system bus allows the CPU to communicate with each subsystem and to control the execution of instructions from system memory or a fixed disk, as well as the exchange of information between subsystems. The system memory and/or the fixed disk may embody a computer readable medium.

The controller 102 is connected to an LED light source 104. The LED light source 104 includes a single emitter body that contains a plurality of LEDs. Each LED of the plurality of LEDs is configured to emit a different and unique wavelength of energy with respect to one another. Exemplary LED wavelengths range from 260 to 320 nm. The controller 102 sends control signals to the LED light source. The control signals can cause the LED light source to activate one, all, or a subset of the LEDs. Further, one, all, or a subset of the LEDs can be activated in pulses.

The LED light source 104 is arranged to output energy to a sample cuvette 106, which holds a sample such as a protein assay. A detector arrangement 108 is arranged to receive energy that passes through the sample cuvette 106, i.e., energy not absorbed by the sample within the sample cuvette 106. The detector arrangement 108 can include a photodiode and an associated signal amplifier. An analog signal is generated by the detector arrangement and sent to an A/D converter of the controller.

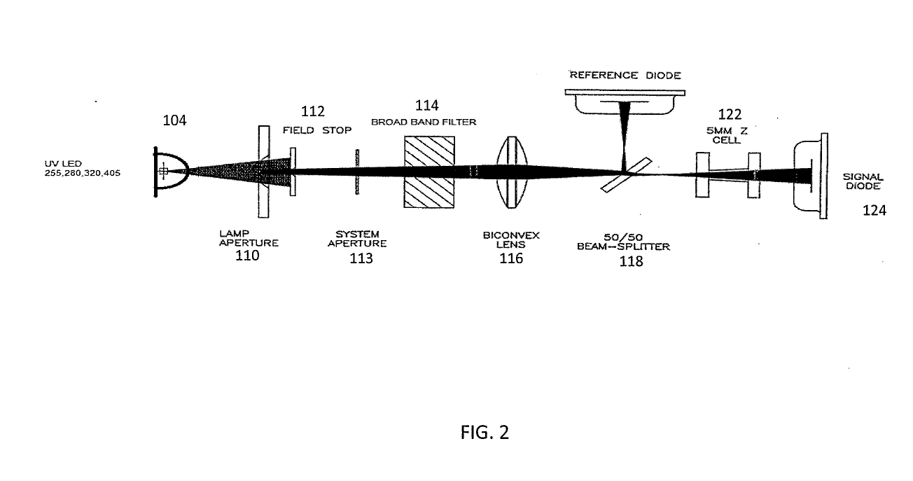

FIG. 2 shows a detailed example of the system 100. Here, the LED light source includes 4 LEDs housed within a single body. The LEDs respectively output 255, 280, 320, and 405 nm wavelengths. The LED light source 104 is arranged to output energy to an aperture arrangement, which includes a lamp aperture 110, field stop 112, and system aperture 113 for reducing a cone of energy emitted from the LED light source down to a beam of energy.

The beam of energy is directed to a broadband filter 114, which helps reduce stray and unwanted artifacts of energy. The broadband filter 114 can be configured to only pass light within a bandwidth of 260-320 nm. However, LED output and bandwidth filtration are not limited to UV wavelengths. Generally, the goal of the broadband filter 114 is to pass only light in the wavelengths of the specific LEDs being used. For example, for a 405 nm LED, the broadband filter would need to pass light up to at least 405 nm. The best performance will be achieved when the broadband filter passes only the range of wavelengths of the LEDs and no others. Accordingly, a wider distribution of different LED wavelengths requires a broadband filter that passes a corresponding wide range of wavelengths; however, this bandwidth must be balanced with the desired performance output, since with increasing bandwidth comes a higher chance for unwanted artifacts.

A filtered beam of energy leaves the broadband filter 114 and is subsequently focused by a biconvex lens 116. The focused beam of energy is directed to a 50/50 beam splitter 118 such that 50% of the beam of energy is directed to a reference diode 120 that is coupled to the controller 102. A signal generated by the reference diode 120 is used as a comparative reference value by the controller 102. The remaining 50% of the beam of energy is directed to a z-path flow cell 122 with a 5 mm light path. A signal generated by the flow cell 122 is sent to the controller 102 for analysis.

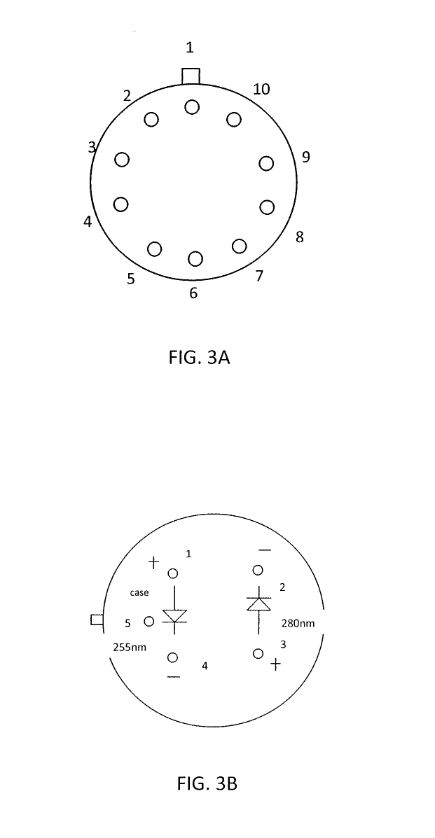

FIG. 3A shows a schematic pin diagram of a LED light source having 3 LEDs. The LED light source constructed as a single emitter body, such as a tubular or circular structure having a plurality of anode-cathode (post and anvil) junctions sharing a single printed circuit board and single lens case. Here, pin 1 is a cathode pin and pin 3 is an anode pin for a 255 nm LED. Pin 5 is a cathode pin and pin 4 is an anode pin for a 280 nm LED. Pin 9 is a cathode pin and pin 7 is an anode pin for a 405 nm LED. Pins 2, 6, 8, and 10 are not used in this embodiment, but can be used for 1-2 additional LEDs.

FIG. 3B shows a schematic pin diagram of an LED light source having 2 LEDs. Here, pin 1 is an anode pin and pin 4 is a cathode pin for a 255 nm LED. Pin 2 is a cathode pin and pin 3 is an anode pin for a 280 nm LED. Pin 5 is connected to a casing (GND) that houses the LEDs.

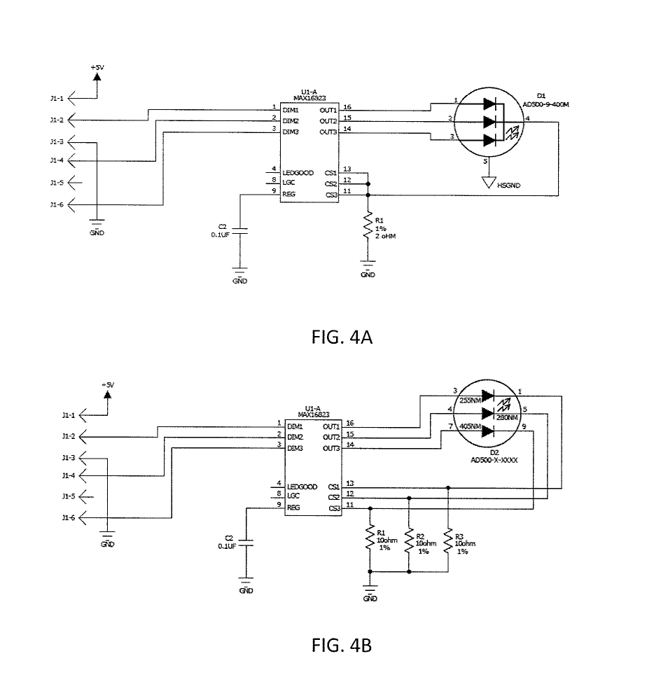

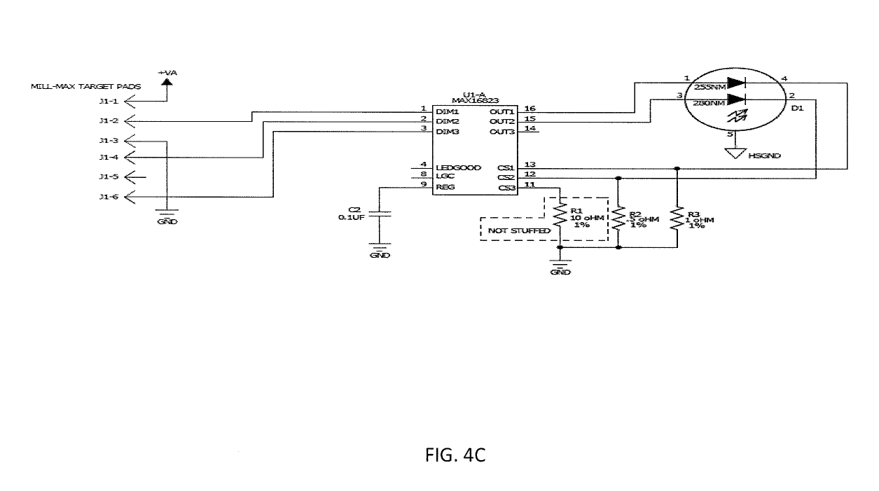

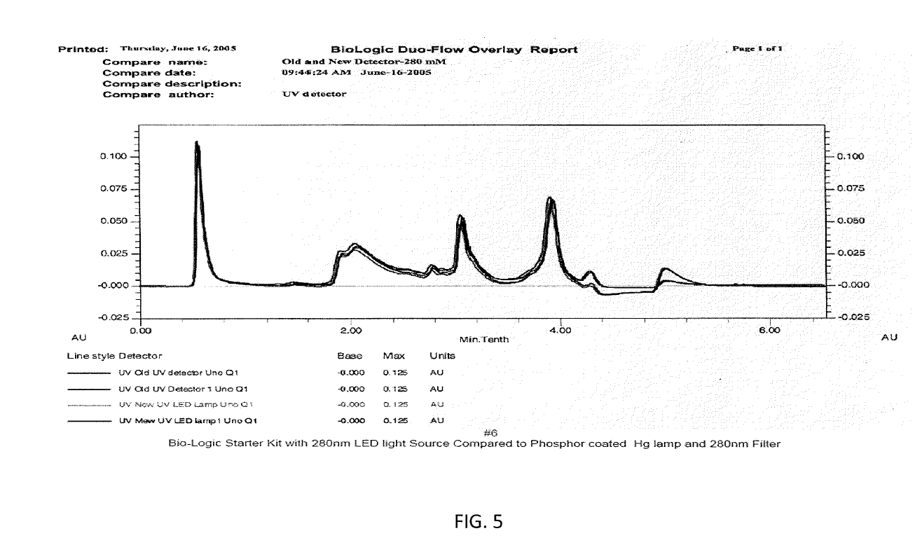

FIG. 4A shows a schematic diagram of a of an LED driver circuit of the controller 102. Here, a commercially available 3-channel constant current LED driver circuit is used to drive up to three LEDs. Additional drivers can be used if additional LEDs are incorporated. One such driver is the MAX16823 by Maxim Integrated™. The controller 102 uses a feedback loop to linearly control the current from each output. The voltage(s) across one or more sense resistors is compared to a fixed reference voltage and the error is amplified to drive the internal power pass device for a particular channel. In the particular configuration shown in FIG. 4A, all LEDS are driven simultaneously, and therefore only one sense resistor is used.

DIM 1 is a low-frequency dimming pin input for channel 1. A logic-low turns off pin OUT1 and a logic-high turns on pin OUT1, which is the current regulator output for one LED. Pins DIM 2 and 3 are similarly arranged to pins OUT2 and OUT3 for channels 2 and 3, respectively.

CS1 is a sense amplifier positive pin input that connects a current-sense resistor between to GND to program the output current level for channel 1. Pins CS2 and CS2 perform the same functions for channels 2 and 3, respectively.

REG is a pin for a 3.4V voltage regulator that connects to a 0.1 μF capacitor to ground (GND). The LCG pin is a LED detection-timing setting. A capacitor may be connected from LGC to ground to set the delay time. Pin LEDGOOD is an open-drain output. A logic-high indicates that the LED connection is good in all three channels. A logic-low indicates an open LED connection.

FIG. 4B shows another schematic diagram of a of an LED driver circuit of the controller 102. The layout depicted is substantially the same as what is shown in FIG. 4A as the same driver is used, however, here the LEDs are driven independently and therefore each is channel includes a separate sense resistor R1-R3. In this manner, each LED channel, and thus each LED, can be driven separately via individual sense circuits.

FIG. 4C shows another schematic diagram of a of an LED driver circuit of the controller 102. The layout depicted is substantially the same as what is shown in FIG. 4B as the same driver is used, however, here 2 LEDs are implemented instead of 3, and therefore channel 3 is not used.

FIG. 5 shows a graph comparing the testing results of the LED system 100 versus a conventional Hg lamp and 280 nm filter, which is a benchmark. Here, the system 100 is configured to output 280 nm. As shown, the signal output of the LED system 100 is nearly identical to the benchmark. Accordingly, the system 100 can provide good analytical results as known devices, while offering the flexibility of multiple outputs.

Although the above description contains much specificity, these should not be construed as limitations on the scope of the invention, but merely as illustrations of some embodiments. Many possible variations and modifications to the invention will be apparent to one skilled in the art upon consideration of this disclosure.

What is claimed is:

1. A detector system comprising:
a single emitter body comprising a plurality of light emitting diodes (LEDs) for emitting a plurality of wavelengths, each LED adapted to emit a different wavelength of light;
a broadband filter adapted to receive the plurality of wavelengths;
a detector arrangement adapted to receive the plurality of wavelengths filtered by the broadband filter; and
a controller adapted to control the plurality of LEDs and detector arrangement.

2. The detector system of claim 1, wherein the single emitter body comprises 2-10 LEDs.

3. The detector system of claim 2, wherein the single emitter body comprises 4 LEDs.

4. The detector system of claim 1, wherein the single emitter body comprises a 280 nm LED and a 260 nm LED.

5. The detector system of claim 4, wherein the single emitter body further comprises a 320 nm LED.

6. The detector system of claim 1, wherein the broadband filter has a bandwidth of 260-320 nm.

7. The detector system of claim 1, wherein the detector arrangement comprises a sample detector adapted to detect absorbance of a sample and a reference detector.

8. The detector system of claim 7, wherein a beam splitter is located between the broadband filter and the detector arrangement.

9. The detector system of claim 1, wherein the controller is adapted to individually operate each LED of the plurality of LEDs.

10. The detector system of claim 1, wherein the controller is adapted to pulse the plurality of LEDs.

11. A method for operating a detector system comprising:
controlling a single emitter body comprising a plurality of light emitting diodes (LEDs) to emit a plurality of wavelengths to a broadband filter, each LED adapted to emit a different band of light;
controlling a detector arrangement to receive the plurality of wavelengths filtered by the broadband filter; and
processing a reference signal and a sample signal received from the detector arrangement to determine a property of a sample.

12. The method of claim 11, wherein the single emitter body comprises 2-10 LEDs.

13. The method of claim 12, wherein the single emitter body comprises 4 LEDs.

14. The method of claim 11, wherein the single emitter body comprises a 280 nm LED and a 260 nm LED.

15. The method of claim 14, wherein the single emitter body further comprises a 320 nm LED.

16. The method of claim 11, wherein the broadband filter has a bandwidth of 260-320 nm.

17. The method of claim 11, wherein the detector arrangement comprises a sample detector adapted to detect absorbance of a sample and a reference detector.

18. The detector system of claim 17, wherein a beam splitter is located between the broadband filter and the detector arrangement.

19. The detector system of claim 1, wherein controlling the single emitter body comprises individually operating each LED of the plurality of LEDs.

20. The detector system of claim 1, wherein controlling the single emitter body comprises pulsing the plurality of LEDs.
